(19) United States
(12) Patent Application Publication
(10) Pub. No.: US 2025/0051978 A1
(43) Pub. Date: Feb. 13, 2025

(54) Fabric with Conductive Core

(71) Applicant: SWNR Development, LLC, Pagosa Springs, CO (US)

(72) Inventors: Dustin English, Pagosa Springs, CO (US); Timm Smith, Pagosa Springs, CO (US); Daniel L. English, Pagosa Springs, CO (US)

(21) Appl. No.: 18/932,071

(22) Filed: Oct. 30, 2024

Related U.S. Application Data
(63) Continuation of application No. 16/582,917, filed on Sep. 25, 2019.
(60) Provisional application No. 62/746,370, filed on Oct. 16, 2018.

(51) Int. Cl. D03D 1/00; B32B 7/025; B32B 7/027; B32B 7/09; B32B 37/00; B32B 37/04; D02G 3/44

(52) U.S. Cl. CPC D03D 1/0088; D02G 3/441; B32B 7/025; B32B 7/027; B32B 7/09; B32B 37/0023; B32B 37/04; B32B 2250/03; B32B 2250/05; B32B 2250/40; B32B 2305/026; B32B 2305/18; B32B 2307/202; D10B 2401/16

(57) ABSTRACT

A stitched fabric including a conductive core and a yarn stitched through and forming stitch holes in the conductive core, where the yarn extends over at least a majority of a width and a length of the fabric. The yarn and the conductive core may be free from contact by another layer on either side of the conductive core. In some circumstances, a barrier layer is disposed over at least one side of the conductive core and a melted portion of the barrier layer fills a portion of the stitch holes.

### CROSS-REFERENCE TO RELATED APPLICATIONS

This application is a continuation of U.S. patent application Ser. No. 16/582,917 filed Sep. 25, 2019, which claims priority to U.S. Provisional Application No. 62/746,370 filed Oct. 16, 2018, each of which is incorporated herein by reference as if reproduced in its entirety.

### BACKGROUND

Conductive fabrics are currently produced using, among other things, conductive yarns. However, this limits the types of yarns that can be used and the types of constructions that are possible for conductive fabrics.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a cross section of an embodiment of a stitched fabric having a conductive core stitched through by a yarn.

FIG. 2 is a cross section of an embodiment of a stitched fabric having a conductive core and a barrier layer stitched through by a yarn.

FIG. 3 is a cross section of an embodiment of a stitched fabric having a conductive core stitched through by a yarn and bearing lights.

FIG. 4 is a cross section of an embodiment of a stitched fabric having a foam layer sandwiched between conductive cores stitched through by a yarn.

FIG. 5 is a cross section of an embodiment of a stitched fabric having a foam layer sandwiched between conductive cores, which are then sandwiched between barrier layers, all of which is stitched through by a yarn.

FIG. 6 is a cross section of an embodiment of a stitched fabric having a conductive core and a multi-component barrier layer stitched through by a yarn.

FIG. 7 is a perspective view of an embodiment fabric having a non-conductive membrane stitched through by a yarn and supporting a conductive circuit.

FIG. 8 is a perspective view of an embodiment fabric having a non-conductive membrane stitched through by a yarn and supporting a radio frequency identification (RFID) circuit.

FIG. 9 is an embodiment of a method of forming the stitched fabric of FIG. 1.

FIG. 10 is an embodiment of a method of forming the stitched fabric of FIG. 7 or FIG. 8.

FIG. 11 is an embodiment of a method of forming the stitched fabric of FIGS. 4-5 and/or 7-8.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

Disclosed herein is a fabric incorporating or benefiting from a conductive core. By constructing a fabric using a conductive core, electricity may be conducted through the fabric without having to use a conductive yarn. As such, garments or wearable articles (e.g., shirts, pants, athletic braces, gloves, footwear, packs, bags, etc.) containing or including a conductive core may be equipped with a variety of different types of useful electronics (e.g., sensors, lights, heaters, transmitters, receivers, circuits, etc.). In addition, by utilizing a conductive core in some embodiments instead of a conductive yarn, the durability of the garment or wearable article may be improved. That is, the conductive core is better able to handle, for example, repeated wash cycles and/or surface abrasion relative to the conductive yarn.

Referring to FIG. 1, an embodiment fabric 100 is illustrated. The fabric 100 may have a variety of beneficial properties. For example, the fabric 100 is able to conduct electric current and/or support electronic components. As shown in FIG. 1, in an embodiment the fabric 100 includes a conductive core 102 and a yarn 104.

The conductive core 102 may be any substrate, composite, laminate, structure, and the like, configured to conduct electrical signals and/or support electronic components. In an embodiment, the conductive core 102 is an electrically conductive film as shown, for example, in FIG. 1. In an embodiment, the conductive core 102 comprises KAPTON® RS, which is an electrically conductive polyimide film commercially available from the E. I. du Pont de Nemours and Company. In an embodiment, the conductive core 102 comprises VELOSTAT®, which is an electrically conductive plastic commercially available from the 3M Company. In an embodiment, the conductive core 102 comprises a transparent conducting film (TCF) or other known type of conductive sheet, layer, and so on. Although a single layer of the conductive core 102 is illustrated, two or more layers may be utilized in the fabric 100.

Still referring to FIG. 1, the yarn 104 is stitched through the conductive core 102. In an embodiment the yarn 104 is a polyester or polyester-blend yarn, a nylon or nylon-blend yarn, or the like. In an embodiment, the yarn 104 is not electrically conductive or not substantially electronically conductive relative to, for example, copper, gold, silver and other well-known electrical conductors. In other words, the yarn 104 is not electrically conductive to the extent that it would be used for transmitting electrical signals in commercially available consumer electronics. The yarn 104 may be chemically or otherwise treated to resist stains, repel moisture, resist flames, or provide other beneficial properties.

As shown, the yarn 104 is stitched through more than a majority (e.g., greater than 50%) of the conductive core 102. In other words, the yarn 104 is stitched over a substantial portion of the length and width of conductive core 102. Even so, the yarn 104 is stitched through the conductive core 102 in a manner that leaves a sufficient amount of the conductive core 102 exposed. Depending on how tightly the stitching is performed, the yarn 104 may permit more or less of the underlying conductive core 102 to be visible and may obscure a portion, but not all, of the underlying conductive core 102.

By using a conductive core 102 within the fabric 100, resistive differences experienced as the fabric 100 flexes may be used to, for example, monitor movement of the wearer of the fabric 100. In an embodiment, the conductive core 102 may be used to heat the fabric 100. In an embodiment, the conductive core 102 may be used to transfer electrical signals through the fabric 100 to power or control electronic devices. In an embodiment, the conductive core 102 may be configured to monitor the number of bends or bend cycles of the wearer of a garment or article made with fabric 100. In an embodiment, the conductive core 102 may connect to a smart watch, a smart phone, a tablet, or other electronic device in order to monitor one or more characteristics.

In an embodiment, the fabric 100 of FIG. 1. is constructed by stitching a conductive and/or non-conductive yarn 104 through the conductive core 102 such that the majority of the surface area of the conductive core 102 is covered. During the stitching process, the yarn 104 forms stitch holes 106 through the conductive core 102 as shown in FIG. 1. In some circumstances, it is desirable to seal off or plug these stitch holes 106. To do so, a barrier layer 208 may be disposed over at least one side of the conductive core 202 as shown in the fabric 200 of FIG. 2. As shown in FIG. 2, the conductive core 202 may be sandwiched between barrier layers 208. As will be more fully explained below, some or all of the stitch holes 206 formed by the yarn 204 are partially or fully filled when the barrier layer 208 is sufficiently heated. For example, the barrier layer 208 may be heated to a thermoplastic state, which allows a portion of the barrier layer 208 to flow and plug a portion of the stitch holes 206 in the barrier layer 208.

The barrier layer 208 is configured to inhibit fluid flow and prevents water or other liquids from reaching the conductive core 202. In other words, the barrier layer 208 is generally water resistant or waterproof. Therefore, the barrier layer 208 functions to discourage fluid flow through the fabric 200. In addition, in an embodiment the barrier layer 208 is also windproof, yet still permits the fabric 200 to be breathable. In other words, the barrier layer 208 is able to block wind from undesirably passing through the fabric 200 while still permitting moisture vapor generated by, for example, body heat to be dissipated. In an embodiment, the barrier layer 208 is stretchable or suitably elastomeric in order to compliment the degree of stretch afforded by the conductive core 202.

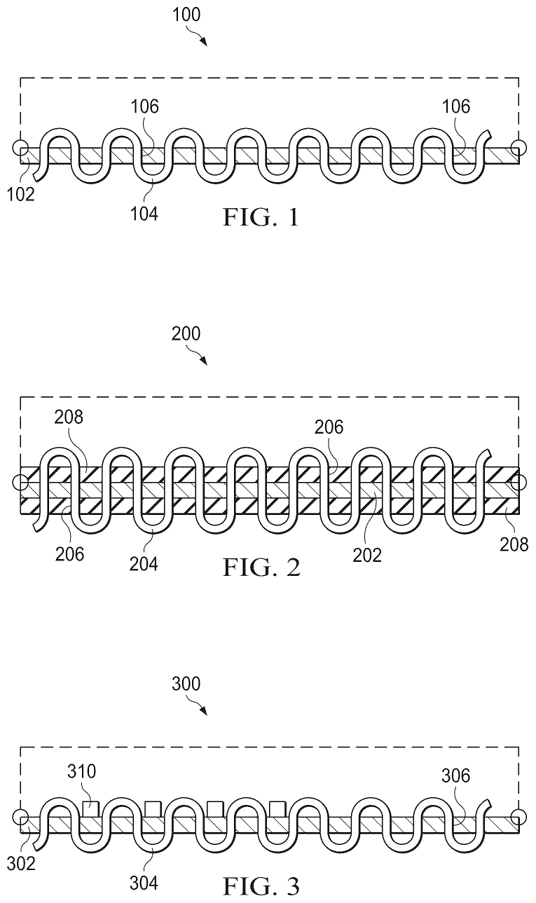

Referring to FIG. 3, an embodiment fabric 300 including a conductive core 302, yarn 304, and lights 310 is illustrated. As shown, stitch holes 306 are formed by the yarn 304. In an embodiment, the lights 310 may be light emitting diode (LED) lights disposed in the spaces between the yarn 304 stitched through the conductive core 302. An electrical current is carried by the conductive core 302 in order to operate the lights 310, which may turn on and off, flash or illuminate in sequence, turn on based on some predetermined criteria (e.g., when a sensor on the conductive core 302 senses a lack of light, etc.), and so on. In an embodiment, the lights 310 may have a variety of different colors and/or be oriented on the conductive core 302 in such a manner so as to display a word, number, phase, etc. when illuminated. In other words, the lights 310 may form a recognizable pattern when illuminated. In an embodiment, all of the lights 310 are illuminated together. In an embodiment, less than all of the available lights 310 are illuminated at the same time.

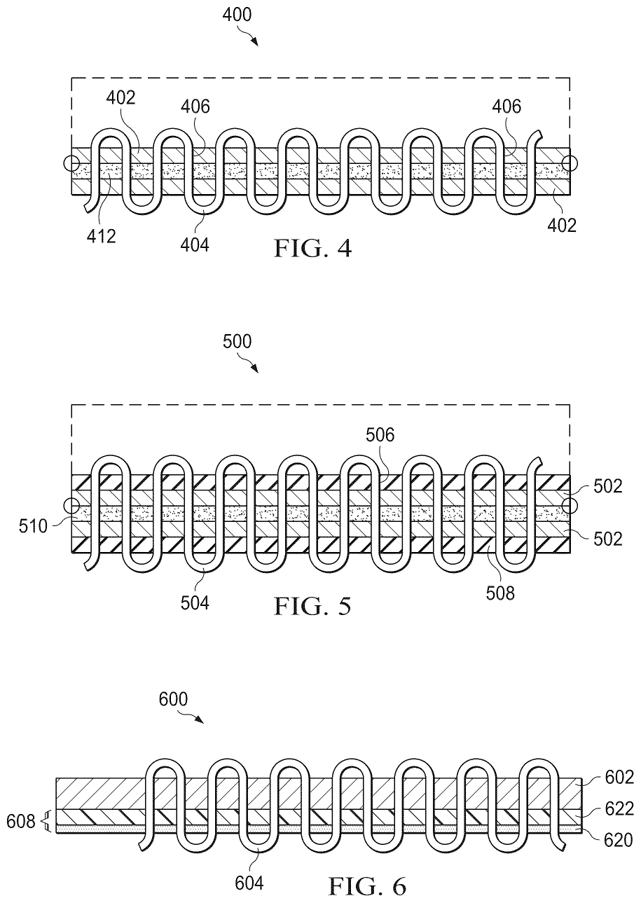

Referring to FIG. 4, an embodiment fabric 400 including a conductive core 402, yarn 404, and a layer of foam 412 is illustrated. As shown, stitch holes 406 are formed by the yarn 404. In an embodiment, the foam 412 is an open cell foam sandwiched between two conductive cores 402. In an embodiment, the foam 412 is configured to collapse when pressure is exerted on the fabric 400 from one or both sides. When the foam 412 has sufficiently collapsed, the opposing conductive cores 402 in FIG. 4 either come into contact with each other or come sufficiently close to each other such that an electrical signal may be transferred from one core to another. In an embodiment, the transferred electrical signal may be used to, for example, pinpoint or measure pressure.

In an embodiment, the yarn 404 is conductive and the foam 412 is not conductive. As shown in FIG. 4, the yarn 404 is stitched through the foam 412 and the conductive core 402 (e.g., conductive film) on either side of the foam. As such, the yarn is able to carry a signal or electrical current from one side of the foam 412 to the other. That is, the yarn is configured to carry an electrical signal from one core to another.

Referring to FIG. 5, an embodiment fabric 500 including a conductive core 502, yarn 504, a layer of foam 510, and at least one barrier layer 508 is illustrated. As shown, stitch holes 506 are formed by the yarn 504. The barrier layer 508 may be configured similar to the barrier layer 208 of FIG. 2. Indeed, the barrier layer 508 on one or both sides of the foam 510 and/or conductive core 502 may be heated to seal or plug stitch holes 506 formed due to the stitching. In an embodiment, the foam 510 is sandwiched between barrier layers 508.

In FIG. 6, a fabric 600 including a conductive core 602, yarn 604, and a composite barrier layer 608 is shown. In an embodiment, the barrier layer 608 comprises an adhesive 620 and an intermediate material 622 (e.g., a porous membrane or a non-porous film) as shown in FIG. 6. In an embodiment, the barrier layer 608 may include several adhesive 620 layers and/or several intermediate material 622 layers.

A melting point of the adhesive 620 is generally lower than a melting point of the intermediate material 622. Therefore, the adhesive 620 may be melted without also melting the intermediate material 622. In other words, the adhesive 620 may be forced to flow through the application of sufficient heat without flowing, or compromising the integrity of, the intermediate material 622.

In an embodiment, the melting point of the adhesive 620 may be between about 140° C. to about 180° C. (about 284° F. to about 356° F.) while the melting point of the intermediate material 622 exceeds about 180° C. (about 356° F.). Where the adhesive 620 and the intermediate material 622 have different distinct melting points as noted above, the barrier layer 608 may be referred to as having an “A-B” type format. In an embodiment, the adhesive 620 is approximately two thousandths of an inch (i.e., 2 mils) and the intermediate material 622 is approximately one thousandth of an inch (i.e., 1 mil).

In general, the adhesive 620 is a thermoplastic, copolyamide, or other suitably meltable type of material capable of bonding two layers of fabric together. A variety of different adhesives 620 may be used in the barrier layer 608. By way of example, the adhesive 620 may be a high-quality textile adhesive such a polyurethane adhesive film, an ethylene-vinyl acetate, and the like. In an embodiment, the adhesive 620 may be heat sensitive, pressure sensitive, or both.

The intermediate material 622 of the barrier layer 608 may be either a membrane or a film formed from a variety of different materials. In an embodiment, the intermediate material 622 is formed from polyurethane, polyester, urethane, polyether, polytetrafluoroethylene (PTFE), or another polymer-based material. The intermediate material 622 may be manufactured using, for example, an extrusion, a melt blowing, or an electrospinning process.

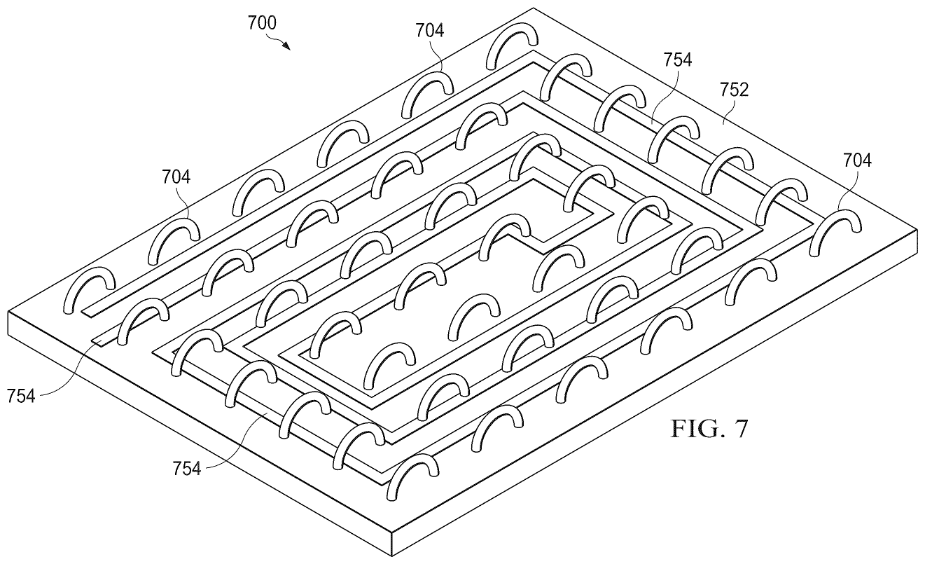

In FIG. 7, a fabric 700 including a non-conductive membrane 752, yarn 704, and a conductive circuit 754 is shown. The non-conductive membrane 752 may be any substrate, composite, laminate, or structure that is substantially non-conductive relative to, for example, copper, gold, silver and other well-known electrical conductors. In other words, the non-conductive membrane 752 is not electrically conductive to the extent that it would be used for transmitting electrical signals in commercially available consumer electronics. The non-conductive membrane 752 may be chemically or otherwise treated to resist stains, repel moisture, resist flames, or provide other beneficial properties.

In an embodiment, the non-conductive membrane 752 is able to support conductive elements, electronic components, and/or electronic circuitry. In an embodiment, the non-conductive membrane 752 is flexible, formed from a water-proof or water resistant material, and/or formed from a breathable material. The non-conductive membrane 752 may be formed from natural fibers, synthetic fibers, and/or some combination thereof. The non-conductive membrane 752 may be a polyester, polyurethane, or other film. The non-conductive membrane 752 may have a variety of colors, textures, and/or patterns.

The yarn 704 may be similar to the yarn 104 of FIG. 1. As shown, the yarn 704 is stitched through the non-conductive membrane 752. In an embodiment, the yarn 704 is not electrically conductive or not substantially electronically conductive relative to, for example, copper, gold, silver and other well-known electrical conductors. In other words, the yarn 704 is not electrically conductive to the extent that it would be used for transmitting electrical signals in commercially available consumer electronics. The yarn 704 may be chemically or otherwise treated to resist stains, repel moisture, resist flames, or provide other beneficial properties.

In an embodiment, the yarn 704 is formed from a composite structure comprising an outer sleeve surrounding an inner core. The outer sleeve may be formed from a material that, when sufficiently heated to a thermoplastic state, partially or fully fills or plugs the stitch holes (e.g., stitch holes 106 in FIG. 1) formed by the yarn 704. In an embodiment, the inner core of the yarn 704 is unaffected by the heating used to transition the outer sleeve to the thermoplastic state and substantially or completely retains its original shape and/or properties. In an embodiment, a yarn having the composite structure may be used in combination with a barrier layer (e.g., barrier layer 208 in FIG. 2) in order to seal or otherwise plug the stitch holes.

The yarn 704 is stitched through the non-conductive membrane 752 in such a manner as to avoid damaging the conductive circuit 754. Although one conductive circuit 754 is illustrated in FIG. 7, it should be appreciated that more than one conductive circuits 754 may be included in the fabric 700 in practical applications. In addition, while the conductive circuit 754 is disposed on only one side of the fabric 700 in FIG. 7, the fabric 700 may include one or more additional conductive circuits 754 on opposing sides of the fabric 700, on edges of the fabric 700, or embedded fully or partially within the fabric 700. The conductive circuit 754 may be printed on the non-conductive membrane 752, glued onto the non-conductive membrane 752, or otherwise affixed to the non-conductive membrane 752.

In an embodiment, the yarn 704 is stitched through more than a majority (e.g., greater than 50%) of the non-conductive membrane 752. In other words, the yarn 704 is stitched over a substantial portion of the length and width of the membrane 752.

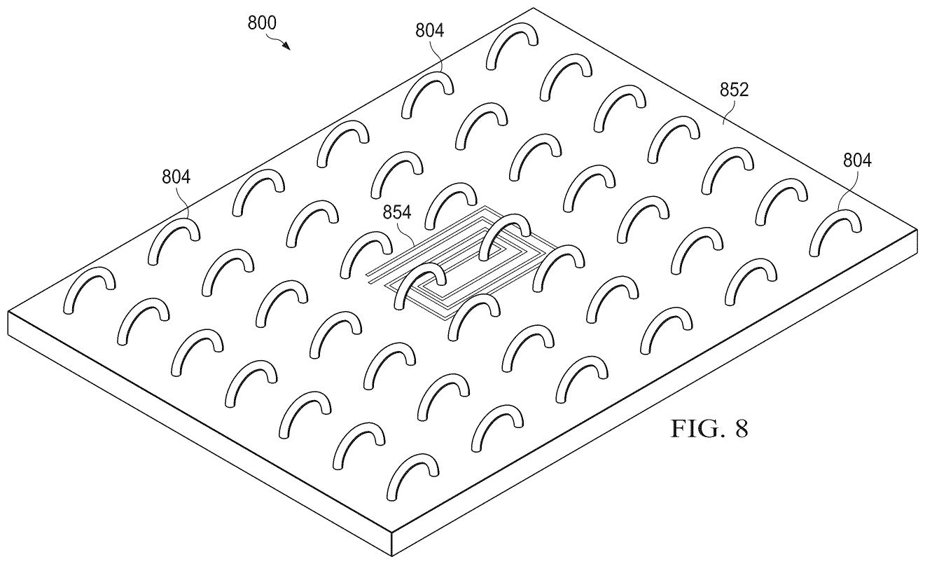

In FIG. 8, a fabric 800 including a non-conductive membrane 852, yarn 804, and a radio frequency identification (RFID) circuit 854 is shown. The non-conductive membrane 852 and the yarn 804 of FIG. 8 are similar to the non-conductive membrane 752 and the yarn 704 of FIG. 7. The RFID circuit 854 may be in the form of a chip, module, tag, transponder, and so on. The RFID circuit 854 may be adhered to the non-conductive membrane 852 in one or more locations or embedded partially within the non-conductive membrane 852. The RFID circuit 854 may be passive. If passive, the RFID circuit 854 is able to collect energy from a nearby RFID reader's interrogating radio waves. The RFID circuit 854 may be active. If active, the RFID circuit 854 has a local power source (such as a battery, solar cell, etc.) and may operate hundreds of meters from the RFID reader. In an embodiment, the RFID circuit 854 is active-passive (a.k.a., battery-assisted passive (BAP)), has a small battery on board, and is activated when in the presence of an RFID reader.

In an embodiment, the RFID circuit 854 may either be read-only, having a factory-assigned serial number that is used as a key into a database, or may be read/write, where object-specific data can be written into the RFID circuit 854 by the system user. Field programmable RFID circuit 854 tags may be write-once, read-multiple, and so on. In an embodiment, the RFID circuit 854 is a ‘blank’ tag that may be written with an electronic product code by the user.

In an embodiment, the RFID circuit 854 contains at least three parts: an integrated circuit for storing and processing information that modulates and demodulates radio-frequency (RF) signals, a mechanism for collecting direct current (DC) power from the incident reader signal, and an antenna for receiving and transmitting the signal. The information corresponding to the RFID circuit 854 may be stored in a non-volatile memory. In an embodiment, the RFID circuit 854 includes either fixed or programmable logic for processing the transmission and sensor data, respectively. Depending on application, the RFID circuit 854 may operate in a variety of different frequency bands. For example, the RFID circuit 854 may operate at 120-150 kilo Hertz (kHz) (low frequency (LF)), 13.56 Mega Hertz (MHz) (high frequency (HF)), 433 MHz (ultra high frequency (UHF)), 865-868 MHz (Europe) or 902-928 MHz (North America) UHF, 2450-5800 MHz (microwave), 3.1-10 giga Hertz (GHz) (microwave), and so on.

In an embodiment, the RFID circuit 854 may be replaced by a Bluetooth® circuit. Bluetooth is a wireless technology standard for exchanging data between devices, both fixed and mobile, over short distances using short-wavelength ultrahigh frequency (UHF) radio waves in the industrial, scientific and medical radio bands, from 2.400 to 2.485 GHz, and building personal area networks (PANs).

In an embodiment, the yarn 704, 804 in FIGS. 7-8 may be a conductive yarn. In such an embodiment, the yarn 704, 804 may be used to carry current and/or signals in cooperation with the conductive circuit 754 and the RFID circuit 854, respectively. In an embodiment, the yarn 704, 804 is capable of touching and/or passing through the non-conductive membrane 752, 852. Such a configuration would enable the current and/or signals to pass back and forth between the yarn 704, 804 and the plane of the non-conductive membrane 752, 852.

In an embodiment, the non-conductive membrane 752, 852 may be electrically shielding. That is, the fabrics 700, 800 may include integrated cores that electrically shield in some embodiments.

As shown in FIGS. 1-8, in an embodiment the fabrics 100-800 are free of any other layer (e.g., a face layer or an interior layer). As such, the conductive core 102-602, the non-conductive membrane 752, 852, and the yarn 104-604 are free from contact by another layer on either side thereof. In an embodiment, the conductive core 602, the barrier layer 608, and the yarn 604 are free from contact by another layer as shown in FIG. 6. Even so, in an embodiment other layers (e.g., a face layer, an interior layer, etc.) may be added to the fabrics.

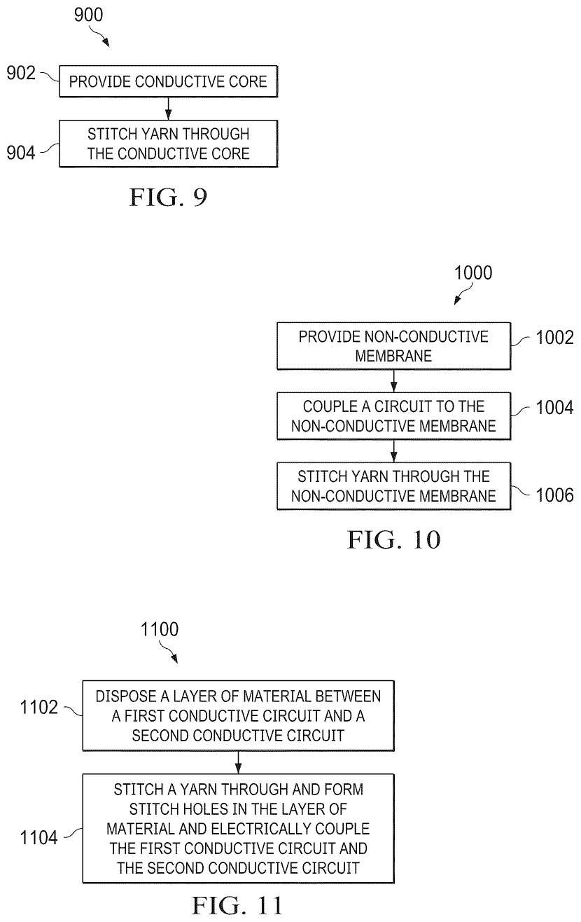

In FIG. 9, a method 900 of forming a fabric is illustrated. In step 902, a conductive core is provided. In step 904, a yarn is stitched through the conductive core as described herein.

In FIG. 10, a method 1000 of forming a fabric is illustrated. In step 1002, a non-conductive membrane is provided. In step 1004, a circuit (e.g., a conductive circuit 754 and/or an RFID circuit 854) is coupled to the non-conductive membrane. In step 1006, a yarn is stitched through the conductive layer as described herein.

In FIG. 11, a method 1100 of forming a fabric is illustrated. In step 1102, a layer of material (e.g., foam 412, 510) is disposed between a first conductive circuit and a second conductive circuit (e.g., the conductive cores 402 or 502). In step 1104, a yarn is stitched through and forms stitch holes in the layer of material and electrically couples the first conductive circuit and the second conductive circuit. In an embodiment, the yarn is also stitched through at least one of the first conductive circuit and a second conductive circuits.

What is claimed is:

1. A stitched fabric, comprising:
a non-conductive membrane;
a conductive circuit coupled to the non-conductive membrane; and
a yarn stitched through and forming stitch holes in the conductive circuit and the non-conductive membrane, wherein the yarn extends over at least a majority of a width and a length of the stitched fabric.

2. The stitched fabric of claim 1, wherein the conductive circuit is configured to propagate an electrical signal despite the stitch holes in the conductive circuit.

3. The stitched fabric of claim 1, wherein the conductive circuit is printed on the non-conductive membrane or glued onto the non-conductive membrane.

4. The stitched fabric of claim 1, wherein the conductive circuit is a radio frequency identification (RFID) circuit or a short-wavelength ultrahigh frequency (UHF) radio wave circuit.

5. The stitched fabric of claim 1, wherein the yarn is formed from a conductive material.

6. The stitched fabric of claim 1, wherein the conductive circuit is partially embedded within the fabric.

7. The stitched fabric of claim 1, wherein the conductive circuit is fully embedded within the fabric.

8. The stitched fabric of claim 1, wherein the conductive circuit includes a battery.

9. The stitched fabric of claim 1, wherein the conductive circuit includes a solar cell.

10. A stitched fabric, comprising:
a layer of material supporting a first conductive circuit and a second conductive circuit; and
a yarn stitched through and forming stitch holes in the layer of material and at least one of the first conductive circuit and the second conductive circuit, and electrically coupling the first conductive circuit and the second conductive circuit.

11. The stitched fabric of claim 10, wherein the layer of material comprises a non-conductive membrane.

12. The stitched fabric of claim 10, wherein the first conductive circuit and the second conductive circuit are each configured to propagate an electrical signal despite the stitch holes in at least one of the first conductive circuit and the second conductive circuit.

13. The stitched fabric of claim 10, wherein the layer of material is an open cell foam that permits an electrical signal to transfer from the first conductive circuit to the second conductive circuit when the open cell foam is collapsed.

14. The stitched fabric of claim 10, wherein a barrier layer is disposed on at least one of the first conductive circuit and the second conductive circuit, and wherein the yarn is stitched through and forms the stitch holes in the barrier layer.

15. The stitched fabric of claim 14, wherein a melted portion of the barrier layer fills at least a portion of the stitch holes.

16. The stitched fabric of claim 10, wherein the first conductive circuit and the second conductive circuit are on opposing sides of the layer of material.

17. The stitched fabric of claim 10, wherein the yarn is stitched though and forms the stitch holes in each of the first conductive circuit and the second conductive circuit.

18. The stitched fabric of claim 10, wherein the layer of material is non-conductive.

19. The stitched fabric of claim 10, wherein the yarn extends over at least a majority of a width and a length of the stitched fabric.

20. The stitched fabric of claim 10, wherein one of the first conductive circuit and the second conductive circuit includes a battery and a solar cell.
